(19) United States
(12) Patent Application Publication
(10) Pub. No.: US 2024/0220212 A1
(43) Pub. Date: Jul. 4, 2024

(54) CONFIGURABLE CUSTOM BLOCK IN DYNAMIC DATASET BUILDER

(71) Applicant: RAKUTEN MOBILE, INC., Tokyo (JP)

(72) Inventors: Murugavel NATARAJAN, Indore (IN); Dewa Putra Bagus SISWANTO, Tokyo (JP); Vidyasagar MISHRA, Indore (IN); Himabindu AVALURU, Singapore (SG)

(73) Assignee: RAKUTEN MOBILE, INC., Tokyo (JP)

(21) Appl. No.: 17/920,955

(22) PCT Filed: Aug. 18, 2022
(86) PCT No.: PCT/US2022/040691

§ 371 Date: Oct. 24, 2022

(51) Int. Cl. G06F 8/34; G06F 8/38

(52) U.S. Cl. CPC G06F 8/34; G06F 8/38

(57) ABSTRACT

A method for generating custom function blocks includes providing a user interface (UI), receiving a first user input to the UI to generate a custom function block, receiving a second user input to the UI to defining at least one condition for the custom function block, generating the custom function block based on the at least one condition, linking the custom function block to at least one database block on the UI, and generating a customized report based on a custom function of the custom function block being applied to at least one database corresponding to the at least one database block, in response to the custom function block being linked to the at least one database block on the UI.

### BACKGROUND

### 1. Field

Apparatuses and methods consistent with example embodiments of the present disclosure relate to user tools for creating custom function blocks in dataset builder systems.

### 2. Description of Related Art

In business logic systems for building dynamic queries using functions, a user may be required to rewrite or assemble blocks in every query when the system needs to be used. A user cannot typically share the query to other users. Furthermore, if a business logic is used in multiple queries, to change the logic, each query is required to be modified. Additionally, if a common function for the business logic needs to be created, the end user cannot create it without the assistance of a third party (e.g., a development team).

### SUMMARY

According to embodiments, systems and methods provide a business logic tool for users to create custom function blocks in a dynamic dataset builder, improving usage in querying data from multiple sources using a simple user interface (UI) design.

According to an aspect of the disclosure, a method for generating custom function blocks may include providing a user interface (UI), receiving a first user input to the UI to generate a custom function block, receiving a second user input to the UI to defining at least one condition for the custom function block, generating the custom function block based on the at least one condition, linking the custom function block to at least one database block on the UI, and generating a customized report based on a custom function of the custom function block being applied to at least one database corresponding to the at least one database block, in response to the custom function block being linked to the at least one database block on the UI.

According to an aspect of the disclosure, a system for generating custom function blocks may include a memory storing instructions, and a processor configured to execute the instructions to provide a UI, receive a first user input to the UI to generate a custom function block, receive a second user input to the UI to defining at least one condition for the custom function block, generate the custom function block based on the at least one condition, link the custom function block to at least one database block on the UI, and generate a customized report based on a custom function of the custom function block being applied to at least one database corresponding to the at least one database block, in response to the custom function block being linked to the at least one database block on the UI.

According to an aspect of the disclosure, a non-transitory, computer-readable storage medium may store instructions that, when executed by at least one processor, cause the at least one processor to provide a UI, receive a first user input to the UI to generate a custom function block, receive a second user input to the UI to defining at least one condition for the custom function block, generate the custom function block based on the at least one condition, link the custom function block to at least one database block on the UI, and generate a customized report based on a custom function of the custom function block being applied to at least one database corresponding to the at least one database block, in response to the custom function block being linked to the at least one database block on the UI.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram of an example environment in which systems and/or methods, described herein, may be implemented;

FIG. 2 is a diagram of example components of a device according to an embodiment;

FIG. 3 is a diagram of a system architecture according to an embodiment;

FIG. 4 is a block diagram of a centralized data management system according to an embodiment;

FIGS. 5A through 5O are diagrams of an example user interface (UI) for generating custom function blocks, according to an embodiment; and

FIG. 6 is a flowchart of a method of generating a custom function, according to an embodiment

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

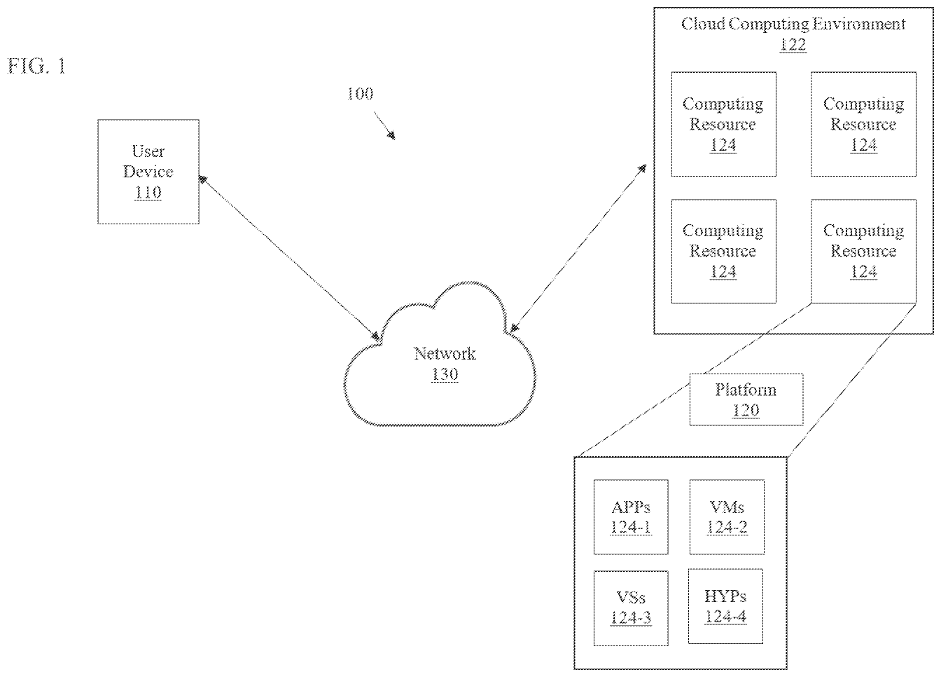

FIG. 1 is a diagram of an example environment 100 in which systems and/or methods, described herein, may be implemented. As shown in FIG. 1, environment 100 may include a user device 110, a platform 120, and a network 130. Devices of environment 100 may interconnect via wired connections, wireless connections, or a combination of wired and wireless connections. In embodiments, any of the functions and operations described with reference to FIG. 1 above may be performed by any combination of elements illustrated in FIG. 1.

User device 110 includes one or more devices capable of receiving, generating, storing, processing, and/or providing information associated with platform 120. For example, user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 110 may receive information from and/or transmit information to platform 120.

Platform 120 includes one or more devices capable of receiving, generating, storing, processing, and/or providing information. In some implementations, platform 120 may include a cloud server or a group of cloud servers. In some implementations, platform 120 may be designed to be modular such that certain software components may be swapped in or out depending on a particular need. As such, platform 120 may be easily and/or quickly reconfigured for different uses.

In some implementations, as shown, platform 120 may be hosted in cloud computing environment 122. Notably, while implementations described herein describe platform 120 as being hosted in cloud computing environment 122, in some implementations, platform 120 may not be cloud-based (i.e., may be implemented outside of a cloud computing environment) or may be partially cloud-based.

Cloud computing environment 122 includes an environment that hosts platform 120. Cloud computing environment 122 may provide computation, software, data access, storage, etc. services that do not require end-user (e.g., user device 110) knowledge of a physical location and configuration of system(s) and/or device(s) that hosts platform 120. As shown, cloud computing environment 122 may include a group of computing resources 124 (referred to collectively as “computing resources 124” and individually as “computing resource 124”).

Computing resource 124 includes one or more personal computers, a cluster of computing devices, workstation computers, server devices, or other types of computation and/or communication devices. In some implementations, computing resource 124 may host platform 120. The cloud resources may include compute instances executing in computing resource 124, storage devices provided in computing resource 124, data transfer devices provided by computing resource 124, etc. In some implementations, computing resource 124 may communicate with other computing resources 124 via wired connections, wireless connections, or a combination of wired and wireless connections.

As further shown in FIG. 1, computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

Application 124-1 includes one or more software applications that may be provided to or accessed by user device 110. Application 124-1 may eliminate a need to install and execute the software applications on user device 110. For example, application 124-1 may include software associated with platform 120 and/or any other software capable of being provided via cloud computing environment 122. In some implementations, one application 124-1 may send/receive information to/from one or more other applications 124-1, via virtual machine 124-2.

Virtual machine 124-2 includes a software implementation of a machine (e.g., a computer) that executes programs like a physical machine. Virtual machine 124-2 may be either a system virtual machine or a process virtual machine, depending upon use and degree of correspondence to any real machine by virtual machine 124-2. A system virtual machine may provide a complete system platform that supports execution of a complete operating system (“OS”). A process virtual machine may execute a single program, and may support a single process. In some implementations, virtual machine 124-2 may execute on behalf of a user (e.g., user device 110), and may manage infrastructure of cloud computing environment 122, such as data management, synchronization, or long-duration data transfers.

Virtualized storage 124-3 includes one or more storage systems and/or one or more devices that use virtualization techniques within the storage systems or devices of computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 124-4 may provide hardware virtualization techniques that allow multiple operating systems (e.g., “guest operating systems”) to execute concurrently on a host computer, such as computing resource 124. Hypervisor 124-4 may present a virtual operating platform to the guest operating systems, and may manage the execution of the guest operating systems. Multiple instances of a variety of operating systems may share virtualized hardware resources.

Network 130 includes one or more wired and/or wireless networks. For example, network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

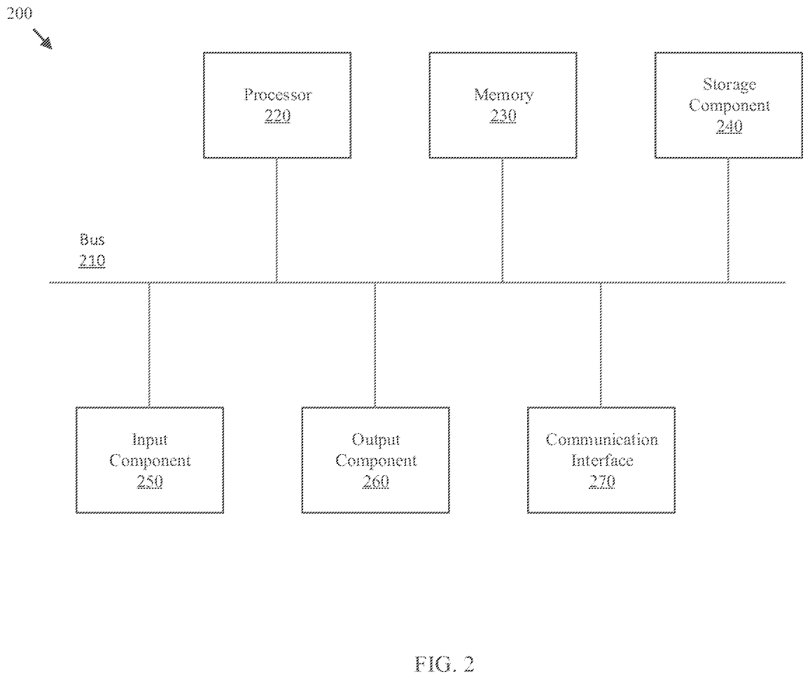

FIG. 2 is a diagram of example components of a device 200. Device 200 may correspond to user device 110 and/or platform 120. As shown in FIG. 2, device 200 may include a bus 210, a processor 220, a memory 230, a storage component 240, an input component 250, an output component 260, and a communication interface 270.

Bus 210 includes a component that permits communication among the components of device 200. Processor 220 may be implemented in hardware, firmware, or a combination of hardware and software. Processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 220 includes one or more processors capable of being programmed to perform a function. Memory 230 includes a random access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of device 200. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 250 includes a component that permits device 200 to receive information, such as via user input (e.g., a touch screen display, a keyboard, a keypad, a mouse, a button, a switch, and/or a microphone). Additionally, or alternatively, input component 250 may include a sensor for sensing information (e.g., a global positioning system (GPS) component, an accelerometer, a gyroscope, and/or an actuator). Output component 260 includes a component that provides output information from device 200 (e.g., a display, a speaker, and/or one or more light-emitting diodes (LEDs)).

Communication interface 270 includes a transceiver-like component (e.g., a transceiver and/or a separate receiver and transmitter) that enables device 200 to communicate with other devices, such as via a wired connection, a wireless connection, or a combination of wired and wireless connections. Communication interface 270 may permit device 200 to receive information from another device and/or provide information to another device. For example, communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

Device 200 may perform one or more processes described herein. Device 200 may perform these processes in response to processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may cause processor 220 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

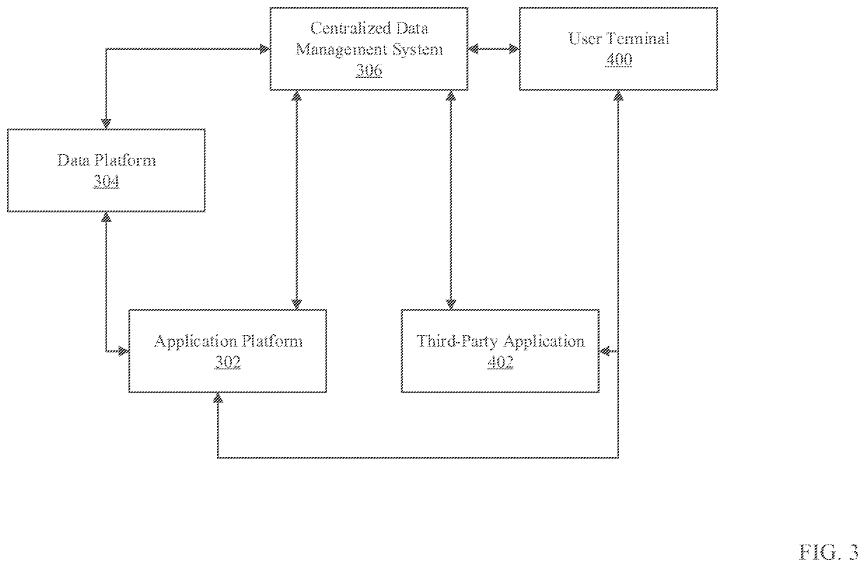

FIG. 3 is a diagram of a system architecture according to one or more embodiments. Referring to FIG. 3, the system architecture includes an application platform 302, a data platform 304, a centralized data management system 306, a user terminal 400, and a third-party application 402.

The application platform 302 is a platform that hosts and/or deploys one or more applications. The application platform 302 may be a cloud platform including one or more servers in which the one or more applications are deployed. For example, the application platform 302 may be a cloud platform for a particular business or enterprise in which applications are deployed for use by employees and/or customers of the business (e.g., applications for day-to-day operations of the business, processing or inputting sales information, communicating with customers, troubleshooting, etc.). The applications in the application platform 302 are configured to output or expose data that may be used for analysis and/or presentation (e.g., visualization, dashboarding, etc.). In some embodiments, the applications are telecommunication software applications.

The data platform 304 is communicatively connected or coupled to the application platform 302 and receives the data output by the one or more applications. The data platform 304 is a storage repository (e.g., one or more servers, data lake, data warehouse, etc.) that stores the data received from the application platform 302. By way of example, the data platform 304 may be a data lake that receives and stores data output from the application platform 302 in its native form. Further, the data platform 304 may store datasets corresponding to the applications in the application platform 302.

The centralized data management system 306 is communicatively connected or coupled to the data platform 304, and is configured to create, edit, and output data visualizations from the data stored in the data platform 304. The centralized data management system 306 may also be communicatively connected or coupled to the application platform 302, and configured to output data visualizations to one or more applications in the application platform 302. The centralized data management system 306 includes one or more computing devices (e.g., servers) having memory for storing executable instructions and at least one processor for executing those instructions to perform the functions (described in further detail below) of the centralized data management system 306.

The user terminal 400 is a user device through which a user accesses the centralized data management system 306 directly or indirectly via an application, namely, an application in the application platform 302 or the third-party application 402. Through the user terminal 400, an end user may generate, configure, and/or view a data visualization of the data management system, as will be set forth in further detail below.

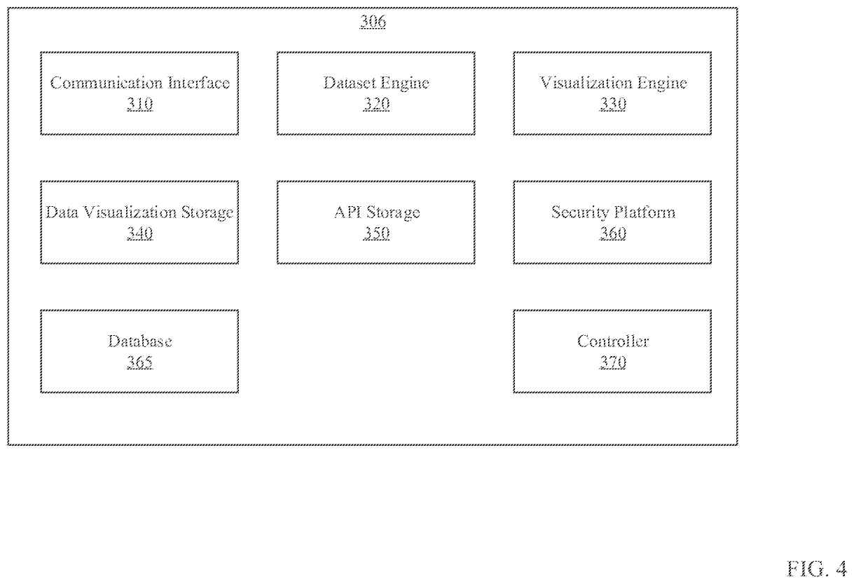

FIG. 4 is a block diagram of the centralized data management system 306 according to an embodiment. Referring to FIG. 4, the centralized data management system 306 includes a communication interface 310, a dataset engine 320, a visualization engine 330, a data visualization storage 340, an application programming interface (API) storage 350, a security platform 360, a database 365, and a controller 370. In some embodiments, the data visualization storage 340, the API storage 350, the security platform 360, and/or the database 365 are external to the centralized data management system 306.

The communication interface 310 is configured to communicatively connect or couple to the data platform 304, the application platform 302, and/or one or more user terminals 400 via a wired and/or wireless connection. The communication interface 310 may also connect to one or more third-party applications 402 in some embodiments. For example, the communication interface 310 may be directly connected to the data platform 304, the application platform 302, the third-party application 402, and/or the one or more user terminals 400 via a cable (e.g., USB, coaxial, etc.). By way of another example, the communication interface 310 may be connected to the data platform 304, the application platform 302, the third-party application 402, and/or the one or more user terminals 400 via at least one network, such as a LAN, a WAN, a MAN, a private network, an ad hoc network, an intranet, the Internet, a fiber optic-based network, a cellular network (e.g., a 5G network, a LTE network, a 3G network, a CDMA network, etc.), a PLMN, a telephone network (e.g., the PSTN), or the like, and/or a combination of these or other types of networks. The communication interface 310 may include at least one of an Ethernet interface, an optical interface, a coaxial interface, an infrared interface, a RF interface, a USB interface, a Wi-Fi interface, a cellular network interface, or the like.

The dataset engine 320 is configured to receive (e.g., request or retrieve) one or more datasets from the data platform 304, via the communication interface 310, and process the data in accordance with a user request. For example, the dataset engine 320 may process the user request and perform an associated action based thereon, such as access a requested dataset from the data platform 304, standardize a form or format of the dataset, and provide the dataset to the visualization engine 330. For example, the data (or datasets) obtained from different applications may be of different formats. Accordingly, the dataset engine 320 converts a format(s) of the datasets into a standardized format for the data management system.

According to an embodiment, the dataset engine 320 may process raw or native data provided by the applications in the application platform 302 to generate datasets or data cubes having a standardized format, and store the datasets or data cubes in the data platform 304. According to another embodiment, a distinct dataset engine (e.g., included in the application platform 302 or the data platform 304) may process native data output by the applications into a standardized format for retrieval and processing by the dataset engine 320 in accordance with a user request.

The visualization engine 330 is configured to create, modify, refresh, and/or publish a data visualization (e.g., report, and/or dashboard) in accordance with a user request. For example, the visualization engine 330 may generate or modify the fields or components of a data visualization (e.g., dashboard, report template, etc.) in accordance with a user request. Further, the visualization engine 330 may obtain, from the dataset engine 320, datasets required to populate the data visualization in response to a user request or based on a predefined (e.g., default or user set) refresh period for a previously generated data visualization.

The data visualization storage 340 is configured to store data visualizations and/or templates generated or provided by the visualization engine 330. The data visualization storage 340 may include any device capable of storing data, such as a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. The data visualization storage 340 may be implemented as a plurality of storage devices. Further, the data visualization storage 340 may store metadata, attributes, or information regarding each data visualization. For example, the metadata, attributes or information may include at least one of a creator (user information) of the data visualization, one or more applications (or modules) that are source of a dataset presented or used by the data visualization, a date and/or time of creation of the data visualization, and a name of the data visualization. The metadata, attributes, or information may be stored together with the data visualization (e.g., within the same file) or separately from the data visualization.

The API storage 350 is configured to store a plurality of APIs for accessing features of the centralized data management system 306. In one or more embodiments, the APIs contain or manage a list of features provided by the centralized data management system 306 (e.g., viewing report A, configuring dashboard B, etc.), and information of users associated with the features (e.g., ID of users who have access to such features, etc.). The APIs may be created by the centralized data management system 306 or provided by one or more external sources. The API storage 350 may include any device capable of storing data, such as a hard disk (e.g., a magnetic disk, an optical disk, a magneto-optic disk, and/or a solid state disk), a CD, a DVD, a floppy disk, a cartridge, a magnetic tape, and/or another type of non-transitory computer-readable medium, along with a corresponding drive. The API storage 350 may be implemented as a plurality of storage devices. The data visualization storage 340 and the API storage 350 may be physically distinct storages or may be logically distinct storages within a same storage device. According to an embodiment, the API storage 350 may be or include an API gateway.

The security platform 360 is configured to authenticate users accessing the data management system 306, and to manage access rights of users and/or applications to the data management system 306. The security platform 360 may store and/or manage at least one of user authentication information, application access rights, user access rights, group access rights, and data management access rights.

The database 365 is configured to store a plurality of data, such as raw data obtained by sources, query data, etc., and the data may be retrieved by the data management system 306 (e.g., in response to a user input) to be presented to the user as is described in detail below. In some embodiments, the data visualization storage 340, API storage 350, and database 365 are included as one data storage. In some embodiments, the database 365 may be omitted and the data platform 304 may perform the functions of the database 365.

The controller 370 is configured to control overall operations of the centralized data management system 306 and the components thereof. The controller 370 may include at last one processor (e.g., a CPU, a system-on-chip (SoC), an APU, a microprocessor, a microcontroller, a DSP, a FPGA, an ASIC, a backend processing engine, or another type of processing component). In some implementations, the controller 370 includes one or more processors capable of being programmed to perform a function. The controller 370 may also include at least one memory, such as a RAM, a ROM, and/or another type of dynamic or static storage device (e.g., a flash memory, a magnetic memory, and/or an optical memory) that stores information and/or instructions for use by the at least one processor.

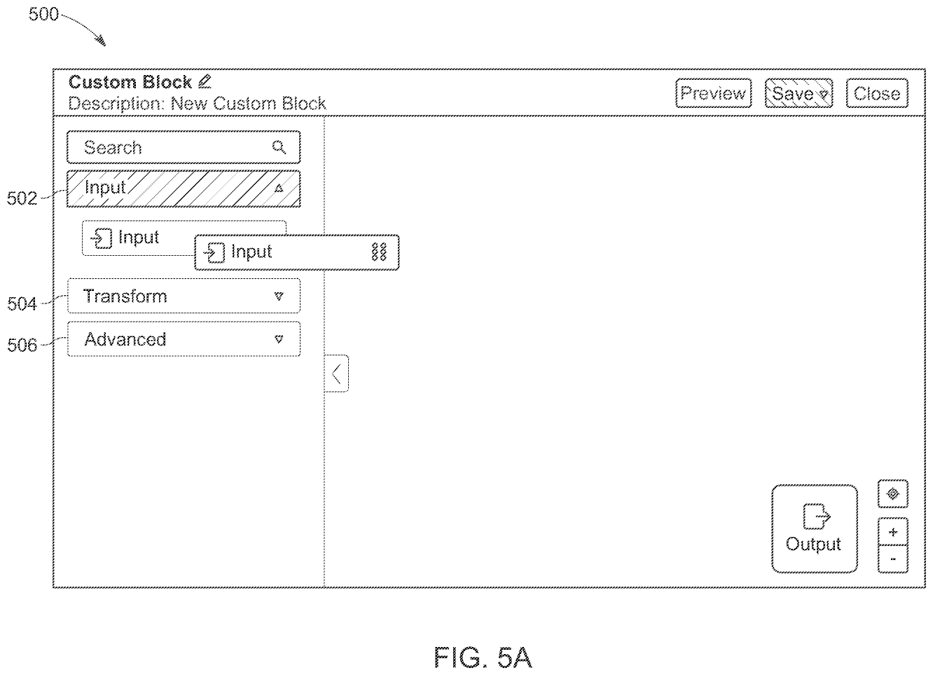

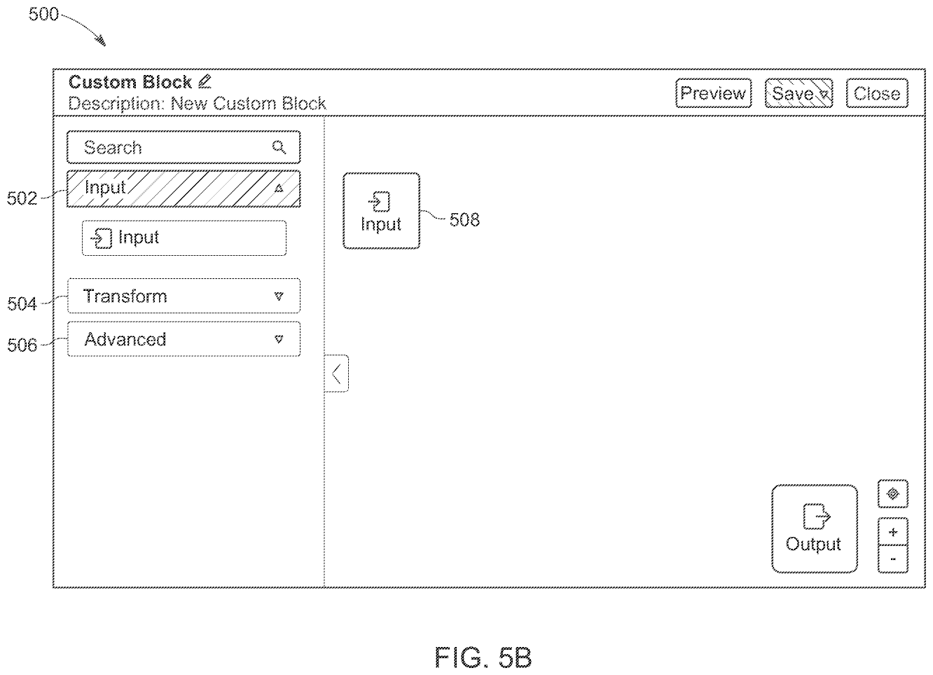

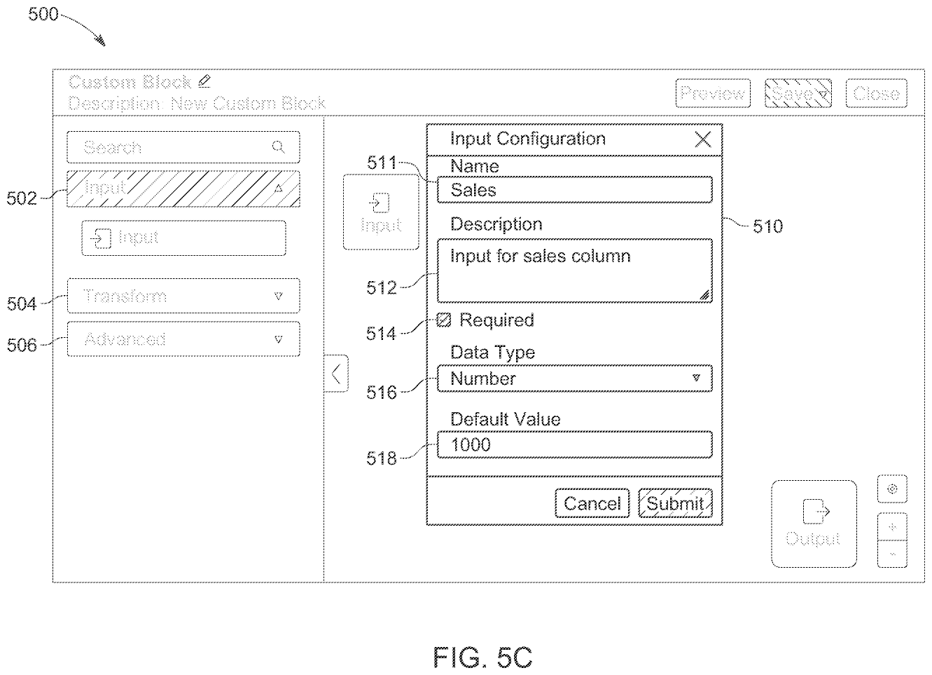

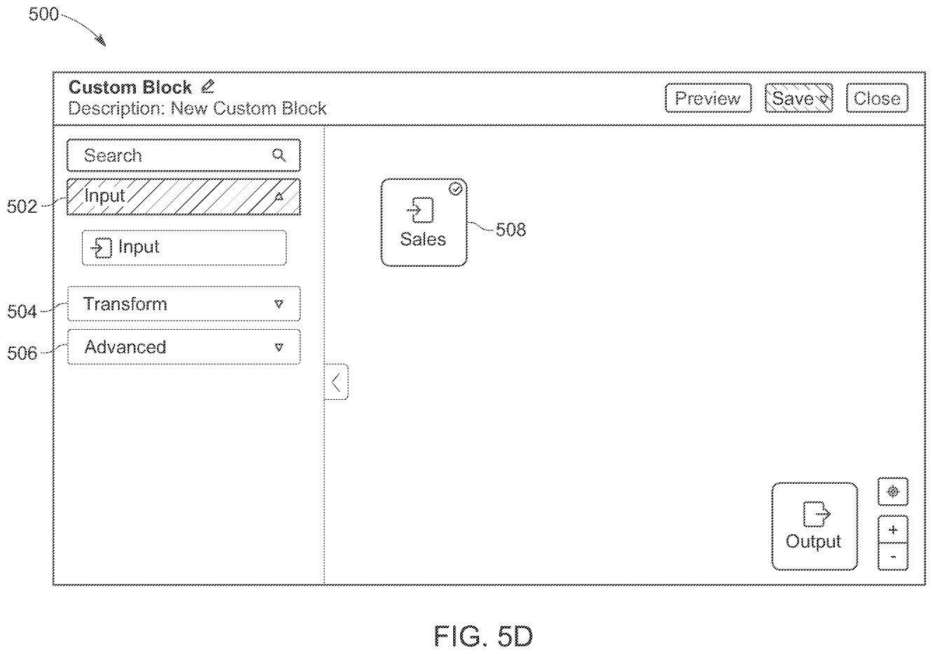

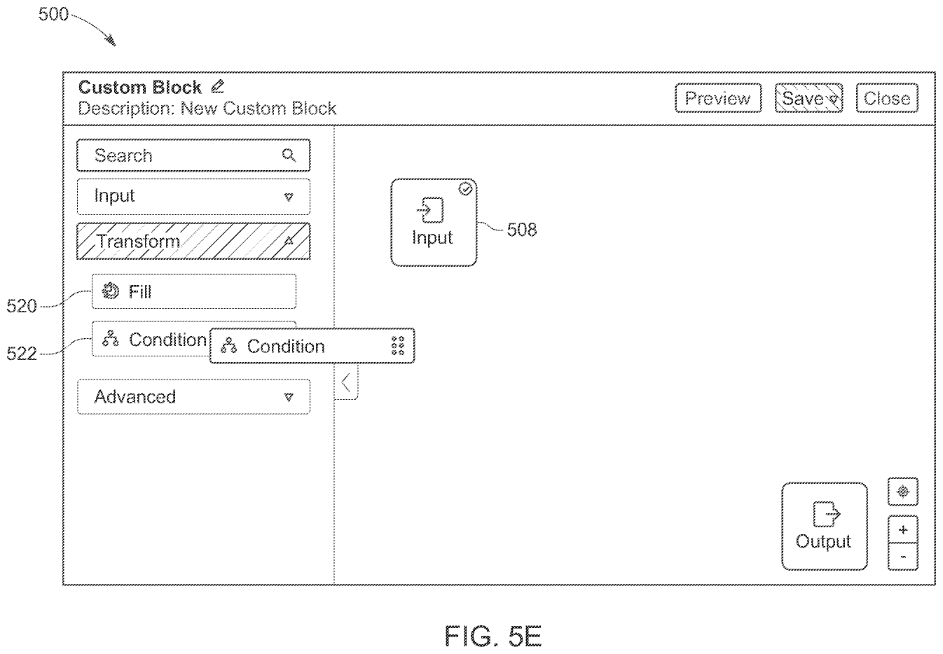

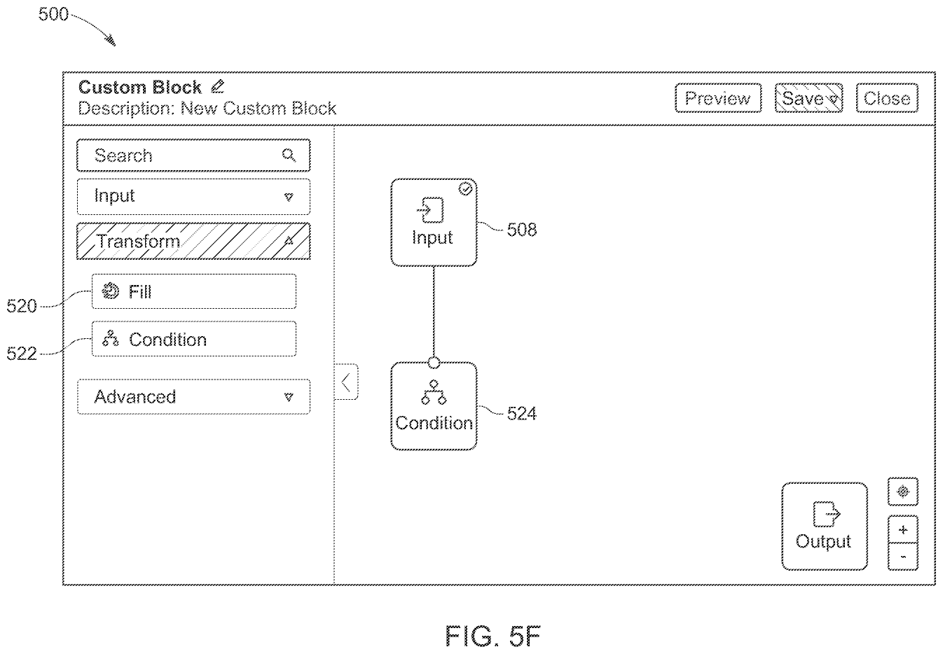

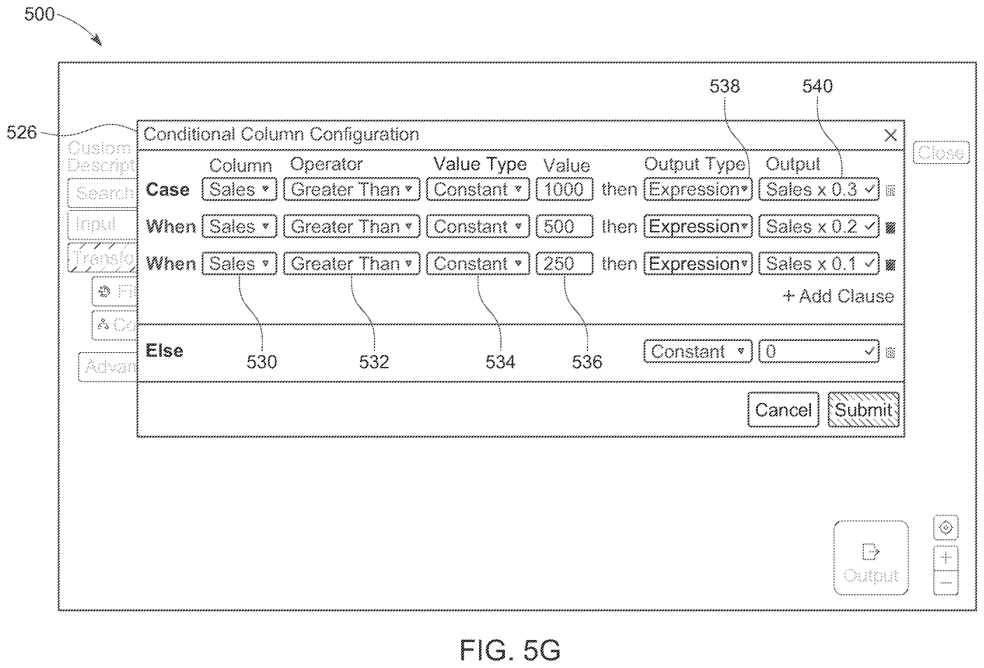

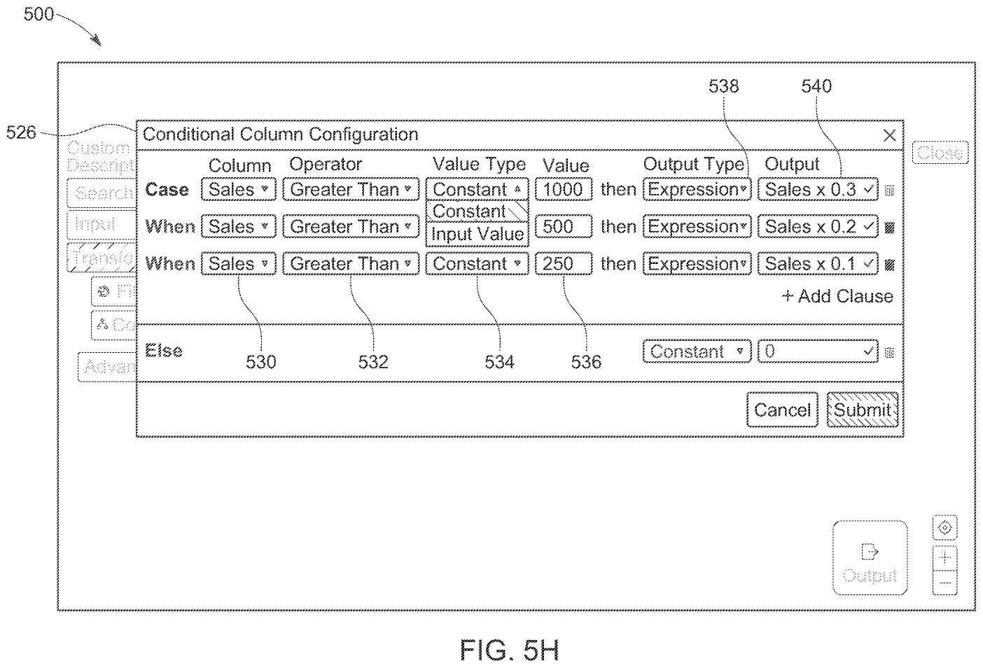

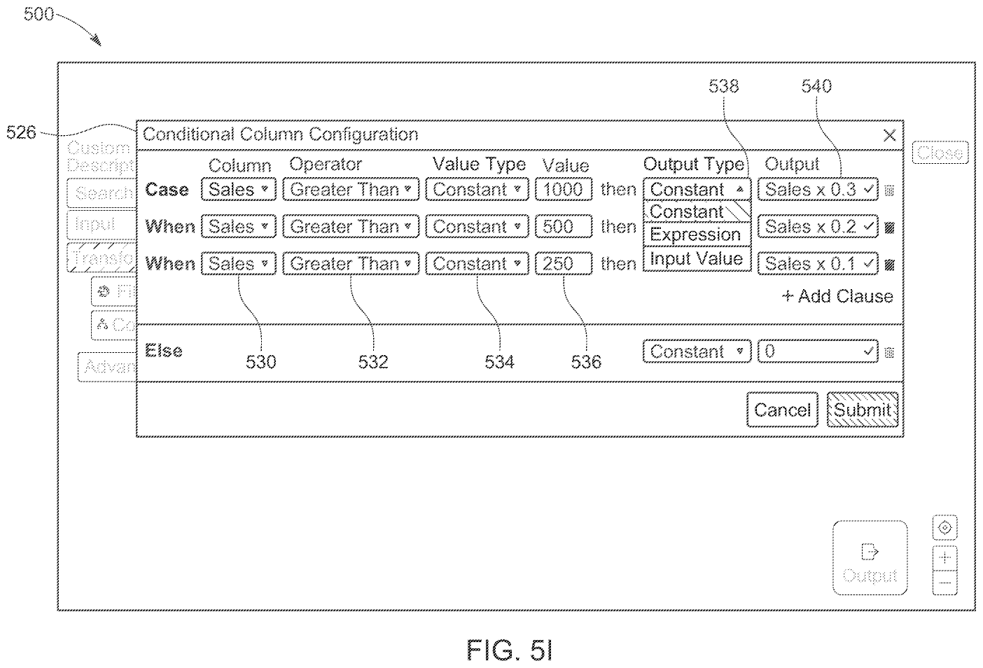

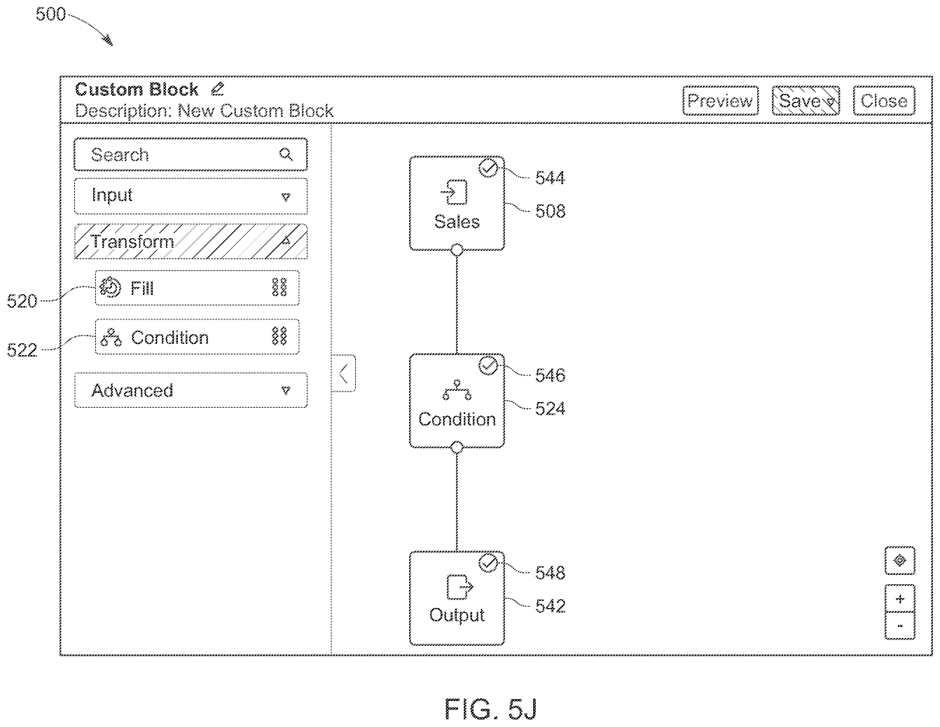

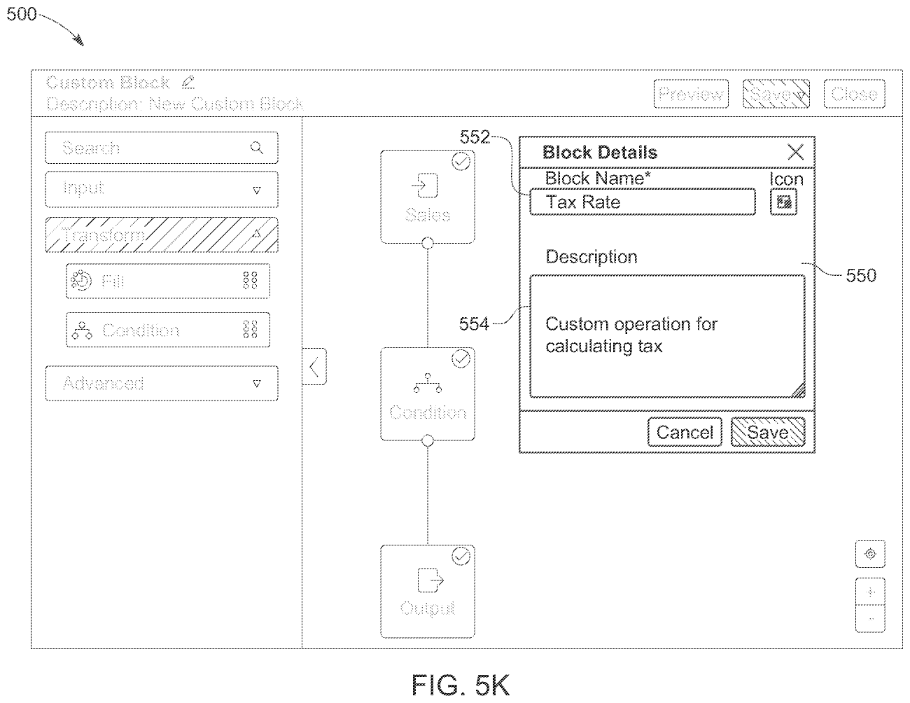

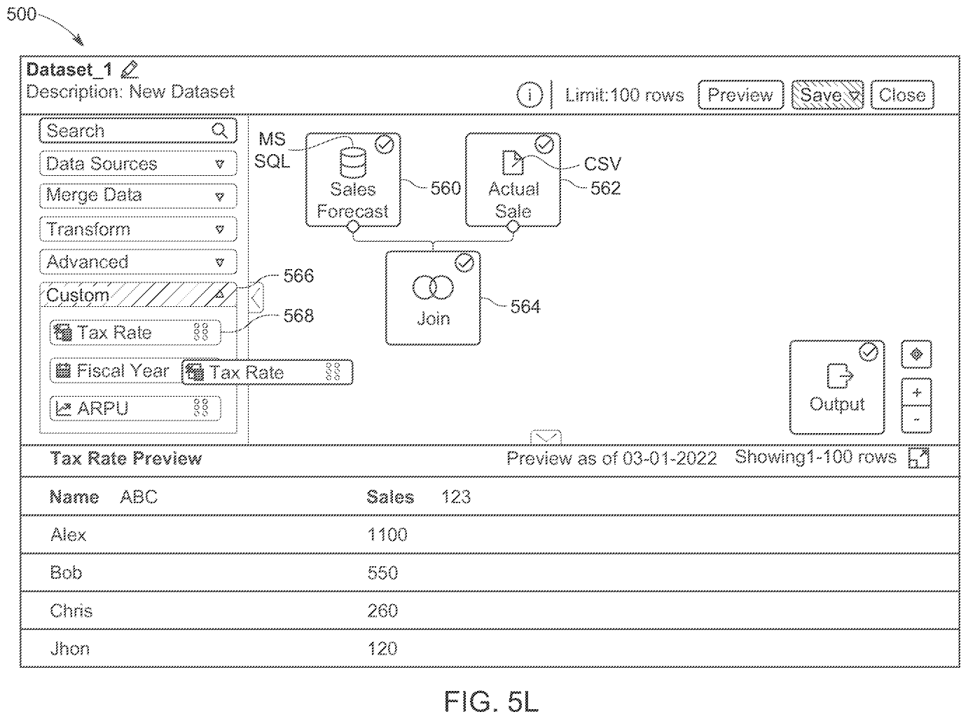

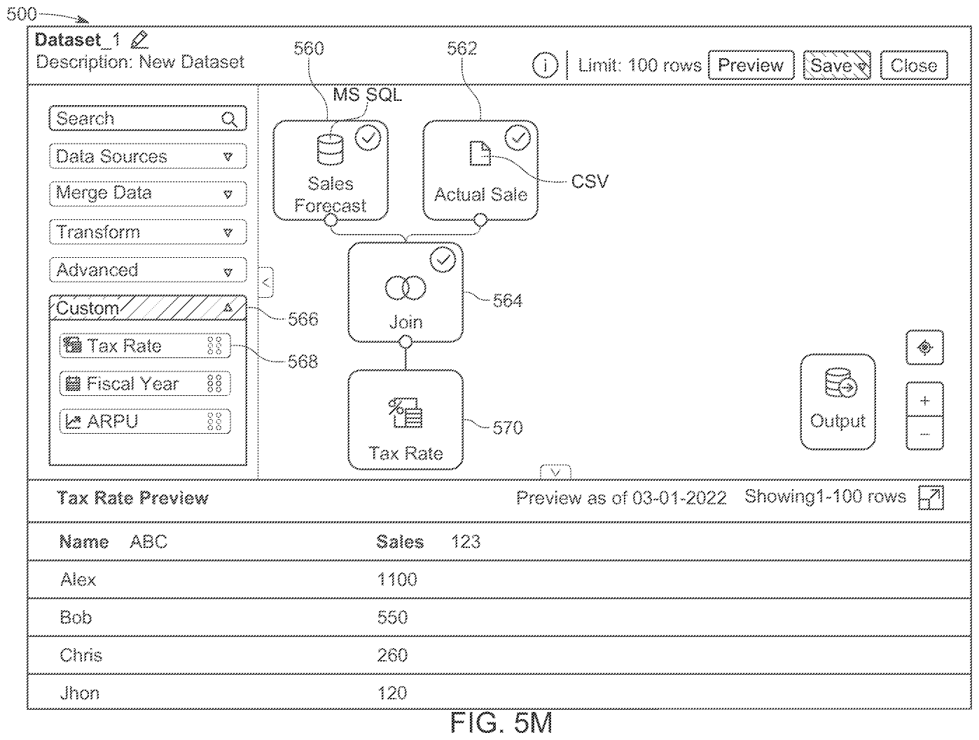

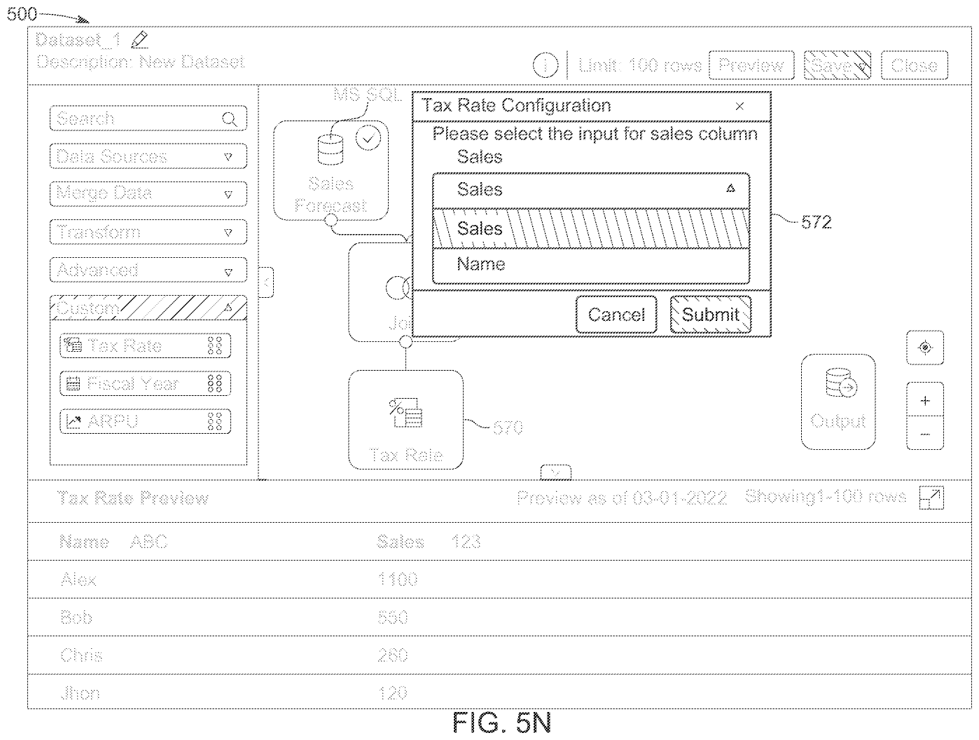

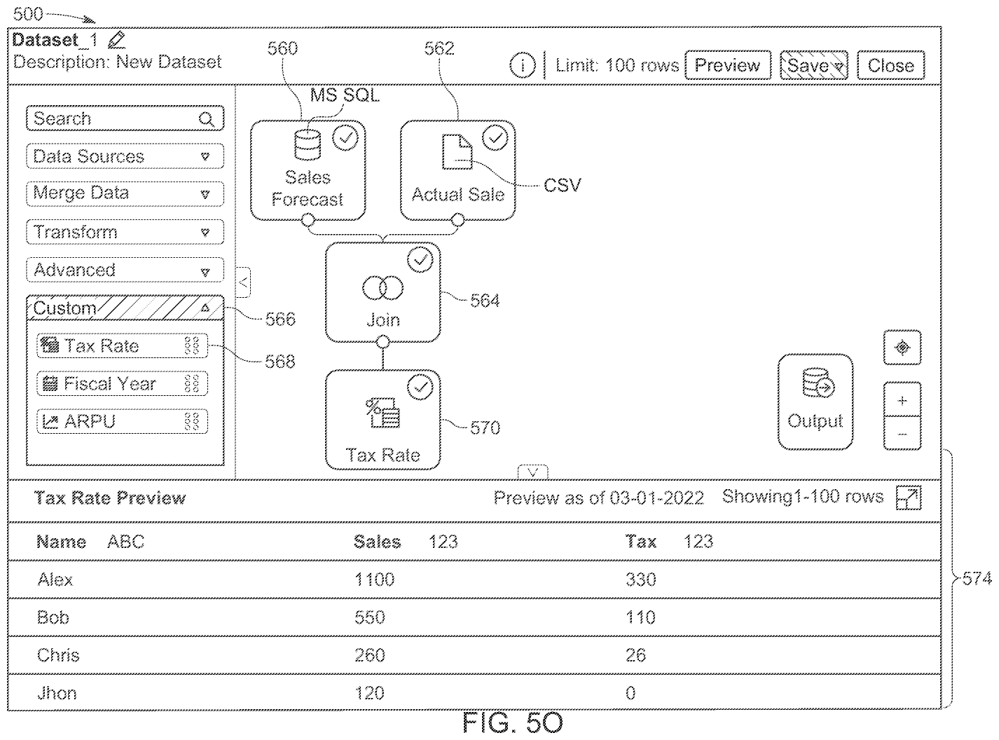

The controller 370 may be configured to generate a graphical UI and to provide the graphical UI to a user terminal 400 via the communication interface 310, in order to allow for access to the centralized data management system 306. The graphical UI (e.g., a webpage or markup language file) may be stored in a storage (which may be included in or external from the centralized data management system 306). According to another embodiment, the graphical UI may be stored in an external server. The graphical UI may be accessed by the user terminal 400 via a location identifier or address (e.g., uniform resource indicator (URI), a uniform resource locator (URL), a file path, etc.). The graphical UI allows an end user to perform an action with the centralized data management system 306 (such as generate custom function blocks in the business logic of the UI, etc.) via certain functional elements presented on the graphical UI, such as buttons, scroll bars, etc. A graphical UI for generating custom function blocks according to an embodiment is described in further detail below with reference to FIGS. 5A-5O.

According to one or more embodiments, the controller 370 (e.g., at least one processor executing instructions) controls operations of at least one of the communication interface 310, the dataset engine 320, the visualization engine 330, the data visualization storage 340, the API storage 350, and the database 365 to generate a data visualization in accordance with a user request.

When a user accesses the system 306 to view data from the database 365 that includes multiple data, the user may use a user terminal 400 to access the centralized data management system 306. The visualization engine 330 may generate and provide a UI for the user to access. A processor of the centralized data management system 306 may determine a role of the user based on a user credential, and provide the UI to the user based on the determined role. In some embodiments, a single UI is generated for users regardless of a user role.

The UI may include various interactive elements, such as buttons, charts, widgets, blocks, etc. Each of the interactive elements may represent a group of predefined queries (e.g., SQL queries) that may be defined by, for example, a system administrator, the user, etc. The interactive elements may include elements representing data stored in the database 365 and element representing a function, such as join, group, etc. Via the UI, the user may select an interactive element associated with the desired data, and then select an interactive element associated with the desired function to be performed on the desired data. Combinations of data interactive elements and function interactive element may be implemented. Based on the selection of interactive elements, the user may indicate to the centralized data management system 306 that the selection of interactive elements has been completed (e.g., pressing a “process” button).

Provided is a system and method for generating custom function blocks in a business logic environment. The system and method may provide a user a UI with which the user may interact to create a custom function to be applied to a database for generating a customized report. The system may provide a UI to the user to generate a custom function by defining inputs and values for the customized report and defining a customized condition to be applied to a database for generating the customized report. The system may generate a custom function block corresponding to the custom function, as well as various other blocks, such as joining blocks and blocks corresponding to databases, and the blocks may be linked by manipulating the position of the blocks on the UI, connecting the blocks on the UI (i.e., the output of one block may be connected as an input to another block), etc. For example, when the custom function block is linked to a database block, the custom function may be applied to the database corresponding to the database block (e.g., generating a customized report).

The system and method provide the UI for a user to interact within a business logic environment without requiring the user to have specific programming knowledge of the business logic, allowing users to define custom functions, even in the event of business logic updates (i.e., in the event of an update, the logic in the custom functions only need to be updated once). The custom functions may be saved and reused easily, such that the function may be applied to various databases at various instances without the need to re-generate a custom function. With the provided systems and method, the custom functions may be easily updated or modified.

FIGS. 5A, 5B, 5C, 5D, 5E, 5F, 5G, 5H, 5I, 5J, 5K, 5L, 5M, 5N and 5O are diagrams of an example UI for generating custom function blocks, according to an embodiment. Referring to FIG. 5A, a user may interact with the UI 500 to create a custom function block for implementing the custom function within the business logic. The UI 500 may include an input selection icon 502, a transform selection icon 504 and an advanced selection icon 506 (in the advanced selection, a user may have blocks that the user may write code in any programming language to process the business logic). The user may define parameters of a customized report via the input selection icon 502. Referring to FIG. 5B, in response to receiving the user input to define the parameters, the system may provide an input block 508 on the UI for visual manipulation by a user, as will be described later.

Referring to FIG. 5C, based on a user selection of either the input selection icon 502 or the input block 508, the system may display an input configuration interface 510, where the user may provide an input name 511, an input description 512, a “required” setting 514 for configuring the input to be required in the defined conditions as is described later, a data type 516 and a default value 518, as parameters for a customized report. As shown in FIG. 5D, upon the input of the name 511 the name of the input block 508 may be updated to reflect the name 511.

Referring to FIG. 5E, the user may select the transform selection icon 504, and a UI 500 may display a sub-menu including a fill selection 520 and a condition selection icon 522. In FIG. 5F, in response to receiving an input from the user for defining a condition (i.e., selecting the condition selection 522), the system may generate a condition block 524 on the UI. The condition block 524 may be linked to the input block 508 such that the parameters set for the customized report may be mapped to the condition block 524.

Referring to FIGS. 5G, 5H, and 5I, upon selection of the condition block 524, the UI 500 may display a condition definition interface 526 for configuring/defining a condition to be applied to a database. As shown in FIGS. 5G, 5H, and 5I, the name parameter defined at the input block 508 is shown as the column name 530 in the condition definition interface 526. In the condition definition interface, the user may define operators 532 (e.g., greater than, less than, other mathematical operations, etc.), value types 534 (e.g., constant, floating, input value, etc.), values 536 (e.g., predetermined value thresholds), an output type 538 (e.g., expression, constant, etc.), and an output 540. In the example embodiment shown in FIGS. 5G, 5H and 5I for applying a tax formula, the condition may be defined as when an entry in a sales column of a database is greater than 1000, the system multiplies the entry by 0.3, when an entry in the sales column of a database is greater than 500, the system multiples the entry by 0.2, and when an entry in the sales column of a database is greater than 250, the system multiples the entry by 0.1. Other such value transformations of data may be implemented. The overall custom function may be stored, for example, in JavaScript Object Notation (JSON) or other suitable formats as will be understood by one of ordinary skill in the art from the disclosure herein.

As shown in FIG. 5J, the input block 508, the condition block 524, and an output block 542 may be linked such that the custom function is defined by these blocks. When the blocks are linked successfully, the system may provide indicators, such as indicators 544, 546 and 548, on the UI 500 (e.g., on the blocks 508, 524 and 542) indicating that the linking is successful. A user of the UI 500 may link the blocks by moving the icons on the UI 500 closer together, causing the UI 500 to identify one or more blocks to be linked. Referring to FIG. 5K, the UI 500 may display a block details interface 550 into which a user may enter details about the custom function block, including the block name 552 and block description 554.

Referring to FIGS. 5L, 5M, 5N and 5O, the UI 500 may display a dataset, where a sales forecast database block 560 corresponding to a sales forecast database, and an actual sale comma-separated values (CSV) block 562, corresponding to an actual sale CSV, are linked together via a joining block 564. The UI 500 may include a custom selection icon 566 for selecting previously defined custom function, such as the custom function “Tax Rate” 568 that was generated as shown in FIGS. 5A-5K. Upon selection of the custom function “Tax Rate” 568, the UI 500 may generate a custom function block 570. The UI 500 may display a custom function configuration interface 572, such that a user can select an input for a particular column of data in a database (e.g., name, sales, etc.). Based on the custom function block 570 being linked with the joining block 564 (and thereby joined to blocks 560 and 562, although the custom function block 570 may be directly linked to each of the blocks 560 and 562, as well as other blocks), a customized report 574 may be generated in the UI 500. In the example embodiment described in FIGS. 5A-5O, the customized report 574 applied the tax formulas to the sales columns of the sales forecast database.

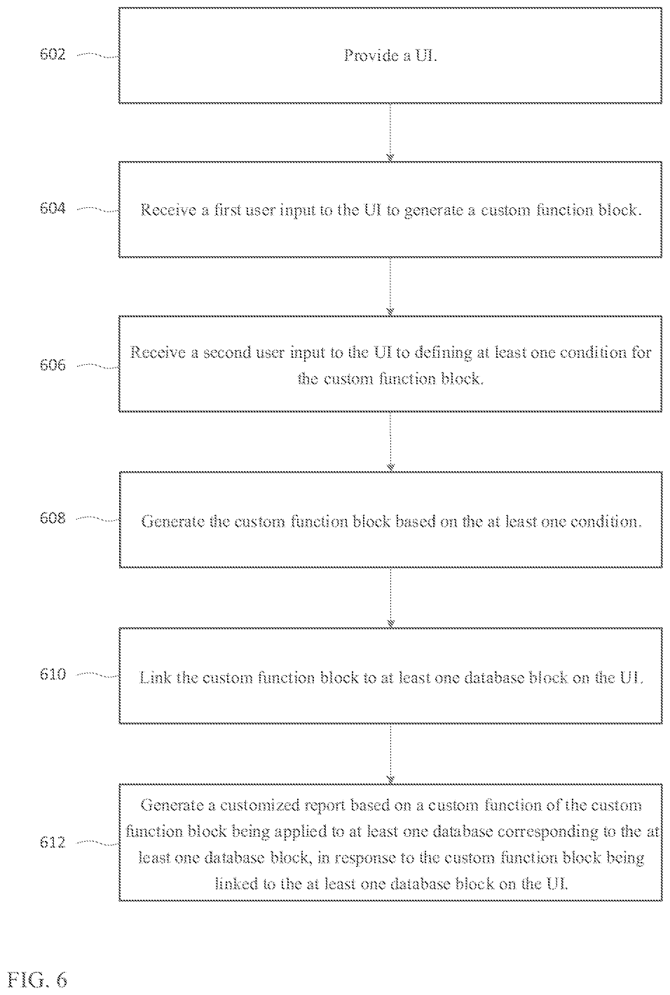

FIG. 6 is a flowchart of a method of generating a custom function, according to an embodiment. In operation 602, the system may provide a UI. In operation 604, the system may receive a first user input to the UI to generate a custom function block. In operation 606, the system may receive a second user input to the UI to defining at least one condition for the custom function block. In operation 608, the system may generate the custom function block based on the at least one condition. In operation 610, the system may link the custom function block to at least one database block on the UI. In operation 612, the system may generate a customized report based on a custom function of the custom function block being applied to at least one database corresponding to the at least one database block, in response to the custom function block being linked to the at least one database block on the UI.

In embodiments, any one of the operations or processes of FIGS. 3-6 may be implemented by or using any one of the elements illustrated in FIGS. 1 and 2.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable CD-ROM, a DVD, a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method for generating custom function blocks, the method comprising:
providing a user interface (UI);
receiving a first user input to the UI to generate a custom function block;
receiving a second user input to the UI to defining at least one condition for the custom function block;
generating the custom function block based on the at least one condition;
linking the custom function block to at least one database block on the UI; and
generating a customized report based on a custom function of the custom function block being applied to at least one database corresponding to the at least one database block, in response to the custom function block being linked to the at least one database block on the UI.

2. The method of claim 1, further comprising providing a condition definition interface on the UI in response to receiving the second user input.

3. The method of claim 2, wherein the condition definition interface comprises a selection interface for selecting parameters of the customized report.

4. The method of claim 1, further comprising providing an input configuration interface in response to receiving the second user input.

5. The method of claim 1, wherein the at least one condition comprises a value transform of data.

6. The method of claim 1, wherein the custom function block and the at least one database block share a same business logic such that the custom function block is configured to be modified without modification to the at least one database block.

7. The method of claim 1, further comprising:
generating a condition block in response to the second user input defining the at least one condition.

8. The method of claim 7, wherein generating the custom function block comprises linking the at least one database block, the condition block, and the output block on the UI.

9. A system for generating custom function blocks, the system comprising:
a memory storing instructions; and
a processor configured to execute the instructions to:
provide a user interface (UI);
receive a first user input to the UI to generate a custom function block;
receive a second user input to the UI to defining at least one condition for the custom function block;
generate the custom function block based on the at least one condition;
link the custom function block to at least one database block on the UI; and
generate a customized report based on a custom function of the custom function block being applied to at least one database corresponding to the at least one database block, in response to the custom function block being linked to the at least one database block on the UI.

10. The system of claim 9, wherein the processor is further configured to execute the instructions to provide a condition definition interface on the UI in response to receiving the second user input.

11. The system of claim 10, wherein the condition definition interface comprises an input selection icon block and an output selection block.

12. The system of claim 9, wherein the processor is further configured to execute the instructions to provide an input configuration interface in response to receiving the second user input.

13. The system of claim 9, wherein the at least one condition comprises a value transform of data.

14. The system of claim 9, wherein the custom function block and the at least one database block share a same business logic such that the custom function block is configured to be modified without modification to the at least one database block.

15. The system of claim 9, wherein the processor is further configured to execute the instructions to:
generate a condition block in response to the second user input defining the at least one condition.

16. The system of claim 15, wherein the processor is configured to execute the instructions to generate the custom function block by linking the at least one database block, the condition block, and the output block on the UI.

17. A non-transitory computer-readable storage medium storing instructions that, when executed by at least one processor, cause the at least one processor to:
provide a user interface (UI);
receive a first user input to the UI to generate a custom function block;
receive a second user input to the UI to defining at least one condition for the custom function block;
generate the custom function block based on the at least one condition;
link the custom function block to at least one database block on the UI; and
generate a customized report based on a custom function of the custom function block being applied to at least one database corresponding to the at least one database block, in response to the custom function block being linked to the at least one database block on the UI.

18. The storage medium of claim 17, wherein the instructions, when executed, further cause the at least one processor to provide a condition definition interface on the UI in response to receiving the second user input.

19. The storage medium of claim 18, wherein the condition definition interface comprises a selection interface for selecting parameters of the customized report.

20. The storage medium of claim 17, wherein the instructions, when executed, further cause the at least one processor to provide an input configuration interface in response to receiving the second user input.
